(19) United States
(12) Patent Application Publication
(10) Pub. No.: US 2024/0152850 A1
(43) Pub. Date: May 9, 2024

(54) INFORMATION PROCESSING METHOD AND INFORMATION PROCESSING APPARATUS

(71) Applicant: TOYOTA JIDOSHA KABUSHIKI KAISHA, Aichi-ken (JP)

(72) Inventors: Kenta TAKESHIMA, Katsushika-ku (JP); Kyohei KITAZAWA, Kawasaki-shi (JP); Nobutoshi SUWA, Taito-ku (JP)

(21) Appl. No.: 18/500,116

(22) Filed: Nov. 2, 2023

(30) Foreign Application Priority Data
Nov. 8, 2022 (JP) 2022-179137

(51) Int. Cl. G06Q 10/0639

(52) U.S. Cl. CPC G06Q 10/06398

(57) ABSTRACT

An information processing method by an information processing apparatus, the information processing method includes acquiring, for a single object to be used by a plurality of users, order data indicating order of use by the plurality of users, upon acquiring an acquisition request for the order data from a first user terminal operated by a first user, transmitting the order data to the first user terminal, and upon accepting an evaluation for a second user among the plurality of users indicated in the order data, notifying a second user terminal operated by the second user of the evaluation.

### CROSS-REFERENCE TO RELATED APPLICATION

This application claims priority to Japanese Patent Application No. 2022-179137, filed on Nov. 8, 2022, the entire contents of which are incorporated herein by reference.

### TECHNICAL FIELD

The present disclosure relates to an information processing method and an information processing apparatus.

### BACKGROUND

It is known to input a specific user from a plurality of users displayed, to input a specific gratitude type from displayed gratitude types, and to transmit gratitude data including the inputted specific gratitude type to a terminal of the inputted specific user (e.g., Patent Literature (PTL) 1).

### CITATION LIST

### Patent Literature

PTL 1: JP 2019-053624 A

### SUMMARY

However, gratitude cannot be transmitted when it is not clear who has performed a good deed.

It would be helpful to make it possible to transmit an evaluation (e.g., gratitude) even in a case in which it is not known who has performed a good deed.

An information processing method according to an embodiment of the present disclosure is an information processing method by an information processing apparatus, the information processing method including:
acquiring, for a single object to be used by a plurality of users, order data indicating order of use by the plurality of users;
upon acquiring an acquisition request for the order data from a first user terminal operated by a first user, transmitting the order data to the first user terminal; and
upon accepting an evaluation for a second user among the plurality of users indicated in the order data, notifying a second user terminal operated by the second user of the evaluation.

An information processing apparatus according to an embodiment of the present disclosure is an information processing apparatus including a controller configured to:
acquire, for a single object to be used by a plurality of users, order data indicating order of use by the plurality of users;
upon acquiring an acquisition request for the order data from a first user terminal operated by a first user, transmit the order data to the first user terminal; and
upon accepting an evaluation for a second user among the plurality of users indicated in the order data, notify a second user terminal operated by the second user of the evaluation.

According to an embodiment of the present disclosure, an evaluation can be transmitted even in a case in which it is not known who has performed a good deed.

### BRIEF DESCRIPTION OF THE DRAWINGS

In the accompanying drawings:

FIG. 1 is a schematic diagram of an information processing system;

FIG. 2 is a diagram illustrating map data;

FIG. 3 is a diagram illustrating a data structure of a utilization database;

FIG. 4 is a diagram illustrating a data structure of a user-related information database;

FIG. 5 is a diagram illustrating order data; and

FIG. 6 is a flowchart illustrating operations of an information processing apparatus.

### DETAILED DESCRIPTION

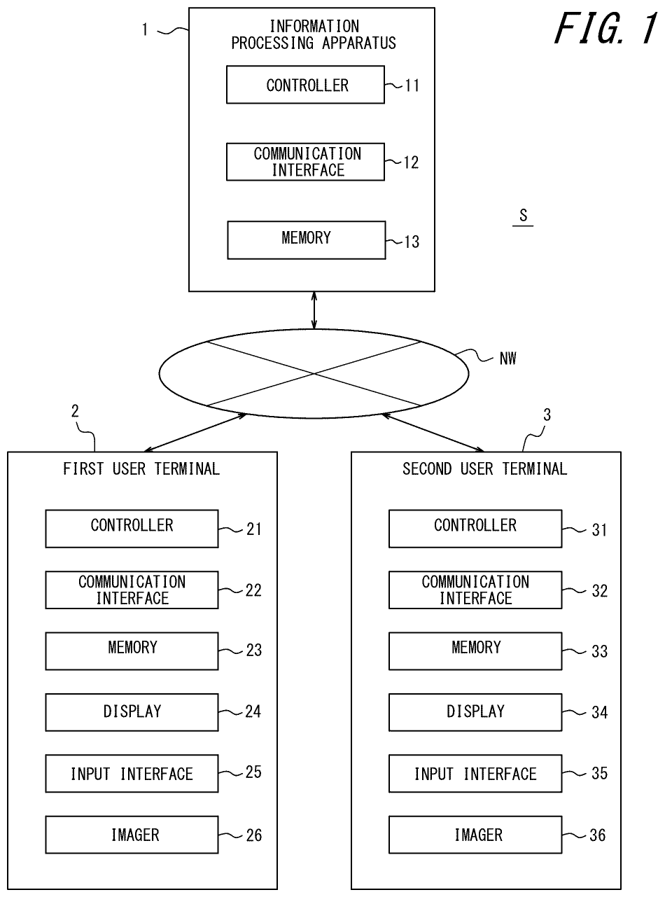

FIG. 1 is a schematic diagram of an information processing system S according to the present embodiment. The information processing system S includes an information processing apparatus 1, a first user terminal 2, and a second user terminal 3, which are communicably connected to each other via a network NW. The network NW includes, for example, a mobile communication network and the Internet.

FIG. 1 illustrates one of the information processing apparatus 1, one of the first user terminal 2, and one of the second user terminal 3, for convenience of explanation. However, the number of information processing apparatuses 1, the number of first user terminals 2, and the number of second user terminals 3 are not limited to one. For example, processing to be executed by the information processing apparatus 1 according to the present embodiment may be executed by a plurality of distributed information processing apparatuses 1. A plurality of first user terminals 2 may be operated by the same user. A plurality of second user terminals 3 may be operated by the same user.

The information processing apparatus 1 is installed in a facility such as a data center. The information processing apparatus 1 is a computer such as a server that belongs to a cloud computing system or another type of computing system.

With reference to FIG. 1, an internal configuration of the information processing apparatus 1 will be described in detail. The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes one or more communication modules for connection to the network NW that conform to wired or wireless Local Area Network (LAN) standards. The communication interface 12 may include a module conforming to one or more mobile communication standards including the Long Term Evolution (LTE) standard, the 4th Generation (4G) 35 standard, or the 5th Generation (5G) standard. The communication interface may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network NW.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a utilization database and a user-related information database as described later.

The first user terminal 2 is a terminal to be operated by a user. The first user terminal 2 is, for example, a mobile device such as a mobile phone, a smartphone, a wearable device, or a tablet. As an alternative example, the first user terminal 2 may be a general purpose device such as a PC, or a dedicated device. The term “PC” is an abbreviation of personal computer.

An internal configuration of the first user terminal 2 will be described in detail. The first user terminal 2 includes a controller 21, a communication interface 22, a memory 23, a display 24, an input interface 25, and an imager 26. The components of the first user terminal 2 are communicably connected to one another, for example, via dedicated lines.

The hardware configurations of the controller 21, the communication interface 22, and the memory 23 of the first user terminal 2 may be the same as those of the controller 11, the communication interface 12, and the memory 13 of the information processing apparatus 1, respectively. The explanation here is omitted.

The display 24 is, for example, a display. The display is, for example, an LCD or an organic EL display. The term “LCD” is an abbreviation of liquid crystal display. The term “EL” is an abbreviation of electro luminescence. The display 24, instead of being included in the first user terminal 2, may be connected to the first user terminal 2 as an external output device. As the connection method, any technology such as USB, HDMI®, or Bluetooth® can be used.

The input interface 25 is, for example, a physical key, a capacitive key, a pointing device, a touch screen integrally provided with a display, or a microphone. The input interface 25 accepts an operation for inputting information to be used for the operations of the first user terminal 2. The input interface 25, instead of being included in the first user terminal 2, may be connected to the first user terminal 2 as an external input device. As the connection method, any technology such as USB, HDMI®, or Bluetooth® can be used. The term “USB” is an abbreviation of Universal Serial Bus. The term “HDMI® ” is an abbreviation of High-Definition Multimedia Interface.

The imager 26 includes a camera. The imager 26 can capture surrounding images. The imager 26 may store the captured images in the memory 23 or transmit the captured images to the controller 21 for image analysis. The images include still images or moving images.

An internal configuration of the second user terminal 3 will be described in detail. The second user terminal 3 includes a controller 31, a communication interface 32, a memory 33, a display 34, an input interface 35, and an imager 36. The components of the second user terminal 3 are communicably connected to one another, for example, via dedicated lines. The hardware configuration of the second user terminal 3 may be identical to that of the first user terminal 2. The explanation here is omitted.

### First Embodiment

Hereinafter, processing executed by the information processing system S will be described in detail with reference to the drawings. The first user terminal 2 is operated by a first user. The second user terminal 3 is operated by a second user.

As an example, the following scene is described here. The first user is looking for a seat to eat at a food court during lunch time, but cannot find an available seat. The second user has just finished eating and informed the first user that his seat is available. The first user then wants to transmit an evaluation (in this case, gratitude) for the second user's action, but does not know contact information on the second user.

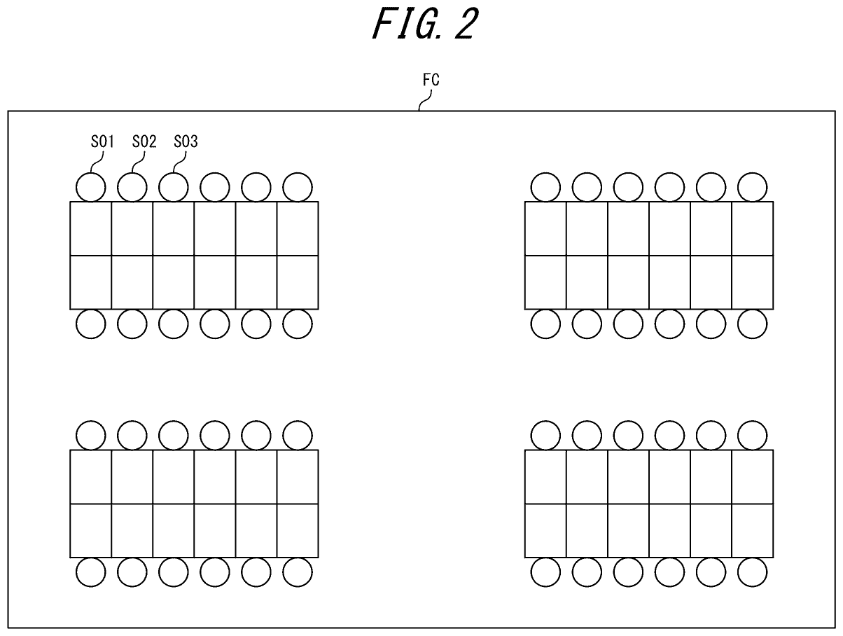

The controller 21 of the first user terminal 2 accepts an operation from the first user and opens an application or browser, etc. to access the information processing apparatus 1. As illustrated in FIG. 2, the controller 21 displays, on the display 24, map data (in this case, a seating map of a food court FC) indicating the locations of objects (in this case, seats). As an alternative example, the objects may be shared objects used by a plurality of users, and may be, for example, any of the following:
Restaurant seats
Vehicles
Playground equipment

The food court FC has a plurality of seats. The plurality of seats includes a seat S01, a seat S02, and a seat S03.

The first user selects an object (in this case, seat S01) used by the first and second users. At this time, the first user terminal 2 transmits, to the information processing apparatus 1, an acquisition request for order data, along with the selection result of the object. The controller 11 of the information processing apparatus 1 acquires the acquisition request for the order data.

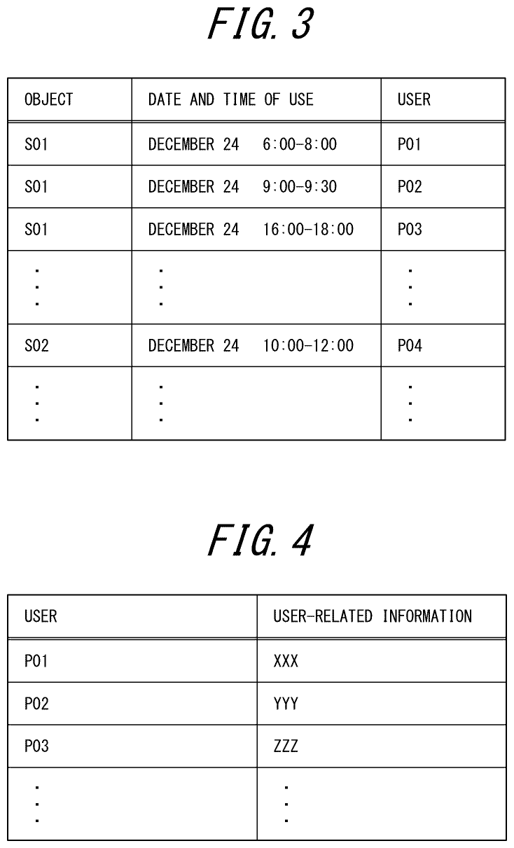

As illustrated in FIG. 3, the memory 13 of the information processing apparatus 1 stores the dates and times of use of the objects and users (corresponding to “user” in FIG. 3) who have used the objects in association with the objects. The users of the objects and the dates and times of use of the objects are identified by wireless communication between any communication medium (e.g., smartphone, tag, etc.) held by each user and each object. As an alternative example, the users of the objects may be identified by images capturing the users and/or login information entered into each object by each user. The images capturing the users may be captured by cameras installed in the food court FC.

The controller 11 of the information processing apparatus 1 acquires, from the memory 13, the order data indicating order of use on the date (here December 24) of use selected by the first user. In the example illustrated in FIG. 3, order number 1 is user P01, order number 2 is user P02, and order number 3 is user P03. As an additional example, the controller 11 may retrieve user-related information corresponding to each user from the user-related information database illustrated in FIG. 4. The user-related information includes, for example, any of the following:
Face image
Gender
Age

The user-related information is registered in advance by the user him/herself. The user-related information that can be disclosed to others can be specified by the user.

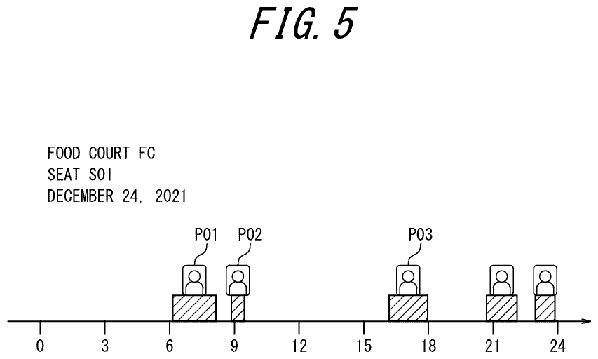

The controller 11 of the information processing apparatus 1 transmits the order data to the first user terminal 2. As illustrated in FIG. 5, the controller 21 of the first user terminal 2 displays the order data on the display 24. As an additional example, the controller 11 may transmit the user-related information in addition to the order data.

The first user selects, on the display 24, the second user to whom the evaluation is to be sent. The first user terminal 2 transmits the selection result to the information processing apparatus 1. Thus, the controller 11 accepts the evaluation for the second user from the first user terminal 2. The first user terminal 2 may transmit an additional message to the second user. The controller 11 of the information processing apparatus 1 notifies the second user terminal 3 operated by the second user of the evaluation. The controller 11 may transmit the additional message to the second user.

### Second Embodiment

Explanations of contents common to the first and second embodiments are omitted here (the same applies hereinafter). In the first embodiment, the order data indicates order in which the seats in the food court FC have been used. In the second embodiment, as an alternative or additional example, the order data may indicate the following:
Order in which a trash can has been opened and closed
Order of passing through a gate
Order in which goods or services have been purchased

In the second embodiment, users opening and closing the trash can, passing through the gate, and purchasing the goods or services are identified by wireless communication between any communication medium held by each user and the object (trash can, gate, store register). The order data may be deleted after a predetermined time.

### Third Embodiment

In a third embodiment, as an additional example of the first embodiment, the controller 11 of the information processing apparatus 1 executes operations including: upon accepting the evaluation (e.g., “thank you” or “nice”) for the second user from the first user terminal 2 operated by the first user, notifying the second user terminal 3 operated by the second user of the evaluation; and upon acquiring a notification (e.g., a notification transmitted by pressing a “wrong” button) indicating that a notification recipient of the evaluation is incorrect, estimating or determining a correct notification recipient and forwarding the evaluation to the estimated or determined notification recipient. Specifically, the following is described.

In a case in which the second user knows the correct notification recipient, the second user notifies the information processing apparatus 1 via the second user terminal 3 of the correct notification recipient. The controller 11 of the information processing apparatus 1 transmits the evaluation to the correct notification recipient.

In a case in which the correct notification recipient is unknown, the controller 11 acquires, from the first user terminal 2, conditions for identifying the correct notification recipient. The conditions may be, for example, any of the following:
Age
Gender
Location
Time
Action (e.g., picking up trash)
Image

The controller 11 identifies a user who is similar to the second user by applying an evaluation function to the conditions, and estimates the identified user as the correct notification recipient. At this time, the controller 11 may rank users similar to the second user who are more likely to be the correct notification recipient (e.g., users to whom gratitude is often transmitted) and notify the first user terminal 2, and estimate a user selected by the first user terminal 2 as the correct notification recipient. As an alternative example, the controller 11 may acquire, from the first user terminal 2, the conditions and the confidence level about the accuracy of the conditions, and apply an evaluation function to the conditions and the confidence level. As an alternative example, among the conditions, conditions that are shared with the second user or the correct notification recipient may be set by the first user. The reason for this is that, for example, in a case in which the condition “80s” is specified, it could be considered rude if it is notified to a user in his/her 50s.

The controller 11 may estimate one or more other users who have been within a predetermined range from the second user as correct notification recipients. The reason for this is that someone in the surrounding area may know the correct notification recipient. A notification status may be viewable by the one or more other users.

The controller 11 may estimate the correct notification recipient by voting from the one or more other users. The controller 11 may forward the evaluation only in a case in which a permission to forward the evaluation to the correct notification recipient is acquired from the first user terminal 2.

The third embodiment allows the evaluation to be transmitted accurately.

### Fourth Embodiment

In a fourth embodiment as an additional example of the first embodiment, the controller 11 of the information processing apparatus 1 can execute operations including: detecting a difference in a specific parameter (e.g., stain, odor, thickness) that has an influence on the degree of customer satisfaction between two adjacent processes of a service (e.g., cleaning) constituted of a plurality of processes (e.g., stain confirmation process, washing process, drying process, ironing process, inspection process); estimating, for each process, the degree of influence on the degree of customer satisfaction from a magnitude of the difference; upon accepting, from the first user terminal 2 operated by a user, an acquisition request for information indicating the degree of influence, notifying the first user terminal 2 of the information indicating the degree of influence; and upon accepting, from the first user terminal 2, an evaluation (e.g., “thank you”, “nice”) for a specific process, notifying the second user terminal 3 operated by a person in charge associated with the specific process of the evaluation.

The controller 11 can suggest, to the first user terminal 2, a process with the most influence. The specific parameter is detected by a sensor (e.g., camera, smell sensor, laser to measure thickness) installed in a location (e.g., factory) at which the plurality of processes is carried out. In a case in which there is a plurality of specific parameters, a parameter to be used can be selected by the user.

According to the fourth embodiment, the evaluation (e.g., appreciation) can be conveyed to someone who is not directly known or distantly related to the user.

### Fifth Embodiment

In a fifth embodiment as an additional example of the first embodiment, the controller 11 of the information processing apparatus 1 executes operations including: detecting first data indicating that the first user of the first user terminal 2 has performed an action that is determined to help the second user; detecting second data indicating that the second user has performed an action that is determined to help a third user; and notifying the first user terminal 2 of the contents of the second data (e.g., by displaying in a string or by text). Specifically, the following is described.

The time back and forth between the help from the first user to the second user and the help from the second user to the third user is irrelevant. The controller 11 generates and transmits, to the first user terminal 2, display information displaying an icon corresponding to each user and an arrow indicating that the action that is determined to be help has been performed. The contents of the icon can be set by each user. If nothing is set, only a plot is required.

Starting from the first user, the controller 11 traces, in one direction, counterparts of actions that are determined to be help. Upon determining that the first user or a user (e.g., a family member) related to the first user is included in the detected users, the controller 11 notifies the first user terminal 2 of the detection result (e.g., notifies that gratitude has been circulated).

Starting from the first user, the controller 11 traces, in one direction, all counterparts of actions that are determined to be help, and notifies the first user terminal 2 of the number of the detected users (e.g., the number of times gratitude has rippled). The controller 11 generates a ranking for each starting point for the number of users detected. The ranking may be generated on a period-by-period basis.

Starting from the first user, the controller 11 traces, in one direction, counterparts of actions that are determined to be help. Upon determining that the detected users include a user who belongs to a location different from the location to which the first user belongs or a location at a distance greater than a standard value from the location to which the first user belongs, the controller 11 notifies the first user terminal 2 of the determination result (e.g., notifies a distant place (e.g., Finland) to which gratitude has rippled). A ranking may be generated for each starting point with respect to the distantness of the detected location. The ranking may be generated on a period-by-period basis.

The controller 11 may calculate a numerical value (e.g., happiness (hypothesis: the happier a person is who helps a person whose relationship is distant)) that indicates the distantness of relationship (e.g., distantness of attributes such as place of residence, hobbies, and age, and fewer contacts in daily life) between a user who has performed an action that is determined to be help and a person with whom the action has been performed. In a case in which the numerical value is greater than or equal to a criterion, the controller 11 detects the user who has performed the action that is determined to be help (e.g., an advanced person helping others who serves as a role model for citizens). The controller 11 may calculate the numerical value for each user in a first geographic region. The controller 11 may calculate a numerical value for each user in a second geographic region and compare the numerical value to the numerical value calculated for the first geographic region.

The fifth embodiment has the following effects.
Visualization of the ripple effect or degree of influence of gratitude
Increased motivation to do the next good deed by knowing the ripple effect
Measuring happiness

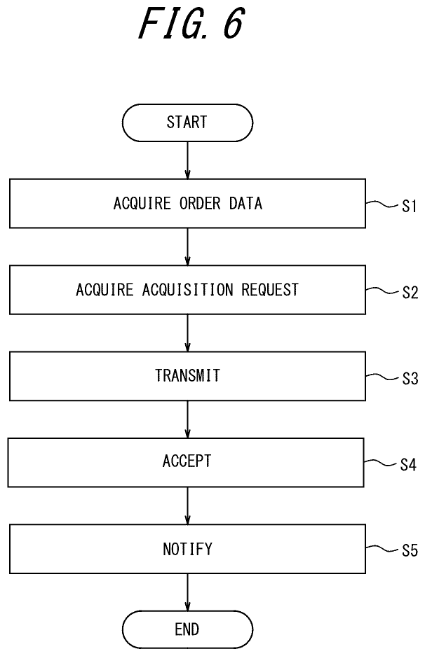

An information processing method performed by the controller 11 of the information processing apparatus 1 will be described with reference to FIG. 6.

In step S1, the controller 11 of the information processing apparatus 1 acquires, for a single object to be used by a plurality of users, order data indicating order of use by the plurality of users. In step S2, the controller 11 acquires an acquisition request for the order data from the first user terminal 2 operated by a first user. In step S3, the controller 11 transmits the order data to the first user terminal 2. In step S4, the controller 11 accepts, from the first user terminal 2, an evaluation for a second user among the plurality of users indicated in the order data. In step S5, the controller 11 notifies the second user terminal 3 operated by the second user of the evaluation.

As described above, according to the present embodiment, the controller 11 executes operations that include acquiring, for the single object to be used by the plurality of users, the order data indicating the order of use by the plurality of users, upon acquiring the acquisition request for the order data from the first user terminal 2 operated by the first user, transmitting the order data to the first user terminal 2, and upon accepting the evaluation for the second user among the plurality of users indicated in the order data, notifying the second user terminal 3 operated by the second user of the evaluation. According to this configuration, the information processing apparatus 1 allows a user to transmit an evaluation even if the user does not know who has performed a good deed.

According to the present embodiment, the operations of the controller 11 also include transmitting map data indicating the location of the single object to the first user terminal 2 and, upon accepting a selection of the single object, transmitting the order data to the first user terminal 2. This configuration allows the information processing apparatus 1 to assist a selection of a target to which the evaluation is to be transmitted.

According to the present embodiment, the operations of the controller 11 also include transmitting, in addition to the order data, the user-related information related to each of the plurality of users to the first user terminal 2. The user-related information to be transmitted to the first user terminal 2 can be specified by each of the plurality of users. This configuration allows the information processing apparatus 1 to protect the personal information on each of the plurality of users.

According to the present embodiment, the operations of the controller 11 also include identifying the users who have used the single object, by the wireless communication between the single object and the communication mediums held by the plurality of users, the images capturing the plurality of users, and/or the login information entered into the single object. According to this configuration, the information processing apparatus 1 can easily and precisely identify the users who have used the single object.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, an embodiment in which a general purpose computer or a general purpose electronic device functions as the information processing apparatus 1 according to the above embodiments can also be implemented. Specifically, a program in which processes for realizing the functions of the information processing apparatus 1 according to the above embodiments are written may be stored in a memory of a general purpose computer, or electronic device and the program may be read and executed by a processor. Accordingly, the present disclosure can also be implemented as a program executable by a processor, or a non-transitory computer readable medium storing the program.

1. An information processing method by an information processing apparatus, the information processing method comprising:
acquiring, for a single object to be used by a plurality of users, order data indicating order of use by the plurality of users;
upon acquiring an acquisition request for the order data from a first user terminal operated by a first user, transmitting the order data to the first user terminal; and
upon accepting an evaluation for a second user among the plurality of users indicated in the order data, notifying a second user terminal operated by the second user of the evaluation.

2. The information processing method according to claim 1, comprising:
transmitting, to the first user terminal, map data indicating a location of the single object; and
upon accepting a selection of the single object, transmitting the order data to the first user terminal.

3. The information processing method according to claim 1, comprising:
transmitting, in addition to the order data, user-related information related to each of the plurality of users, to the first user terminal,
wherein the user-related information to be transmitted to the first user terminal can be specified by each of the plurality of users.

4. The information processing method according to claim 1, comprising identifying a user who has used the single object, by wireless communication between the single object and communication mediums held by the plurality of users, images capturing the plurality of users, and/or login information entered into the single object.

5. An information processing apparatus comprising a controller configured to:
acquire, for a single object to be used by a plurality of users, order data indicating order of use by the plurality of users;
upon acquiring an acquisition request for the order data from a first user terminal operated by a first user, transmit the order data to the first user terminal; and
upon accepting an evaluation for a second user among the plurality of users indicated in the order data, notify a second user terminal operated by the second user of the evaluation.
